(19) United States
(12) Patent Application Publication
(10) Pub. No.: US 2013/0282511 A1
(43) Pub. Date: Oct. 24, 2013

(54) SYSTEM AND METHOD FOR ESTIMATING, SCHEDULING, AND PURCHASING PROJECT SERVICES

(71) Applicants: Shawn Mitchell, Broadlands, VA (US); Nick Mormann, Arlington, VA (US)

(72) Inventors: Shawn Mitchell, Broadlands, VA (US); Nick Mormann, Arlington, VA (US)

(21) Appl. No.: 13/865,961

(22) Filed: Apr. 18, 2013

Related U.S. Application Data
(60) Provisional application No. 61/635,053, filed on Apr. 18, 2012.

(51) Int. Cl. G06Q 30/06

(52) U.S. Cl. CPC G06Q 30/0611
USPC 705/26.4

(57) ABSTRACT

An online system and method for a computer or web-based system enabling users to estimate, schedule, and purchase a variety of home-related services from a trusted group of professional contractors. The system manages a list of prescreened, reputable, and local contractors. Through the present invention, consumers may find local contractors, obtain real time competitively priced quotes from contractors for their services, schedule work to be preformed, and pay or finance the cost of the service. Contractors may also purchase subscriptions tied to U.S. postal codes or zip codes from which they will receive all leads of consumers needing services originating from that postal code for the services they offer.

### RELATED APPLICATION

This application claims priority to U.S. Provisional Patent Application 61/635,053 filed on Apr. 18, 2012, entitled “Online System and Method for Estimating, Scheduling, and Purchasing Project Services”, the entirety of which is incorporated herein.

### BACKGROUND OF THE INVENTION

1. Field of the Invention

The present invention relates to the field of providing a matching database for consumers to receive cost estimates and purchase services from local contractors. More specifically, the invention relates to a system of estimating, scheduling, and purchasing a variety of services from a trusted group of professional contractors by combining specific project details provided by a consumer with specific project pricing provided in advance by a contractor or service provider.

2. Description of the Related Art

Many homeowners, property managers, and renters rely on hiring contractors for many home-related services, such as house cleaning, house painting, plumbing, and other similar services. In order to find a trusted group of professional contractors, many consumers rely on word-of-mouth, internet searches, and reviews. At the same time, many professional contractors rely on word-of-mouth and regional advertising to gain business.

In order to get an estimated cost of a service, many professional contractors need to make physical visits to the location to gather relevant information before giving a quote. This effort can be costly to professional contractor and time consuming for both the consumer and the contractor. A contractor may have to make visits to a number of different clients before securing a job. Similarly, consumers may have to obtain quotes from a number of different contractors before deciding which one to hire.

Thus, a system is needed that provides both consumers and contractors an easy method of doing business with each other. More specifically, there is a need for a system that allows users to find local contractors, obtain quotes, schedule projects, and pay for the service at a centralized easy-to-use online location, such as a web-based system without having to physically meet with the contractor.

### SUMMARY OF THE INVENTION

This summary of the invention is provided to introduce concepts in a simplified form that are further described in the detailed description of the invention. This summary is not intended to identify key or essential inventive concepts of the claimed subject.

The present invention provides for an online system of estimating, scheduling, and purchasing a variety of home-related services from a trusted group of professional contractors. The system manages a list of prescreened, reputable, and local contractors. In addition, the system organizes and categories the contractors by service types (i.e. home cleaning, steam cleaning, lawn mowing, etc.) and postal/zip codes. Through the present invention, consumers may obtain real time competitively priced quotes, schedule work to be performed, and pay or finance the cost of the service.

Further, contractors may use the system to obtain qualified leads in their service areas. Contractors may purchase subscriptions to obtain the leads in a given area. By obtaining the subscription to zip codes or clusters of U.S. postal/zip codes the contractors will receive all leads originating from that postal code for the service(s) they offer. When a consumer obtains a price quote for a particular service type, the system sends the customer lead to the contractor having a subscription for that service with that consumer's zip code. In the preferred embodiment, the system is designed to handle home-related services, but it should be noted that the system may also be designed to handle all types of services, such as computer services, consulting services, catering services, etc.

The present invention also provides a system comprising: at least one server; at least one software application; and at least one database, wherein the system is configured to: receive a request from a user for a real time price quote for a service related to a property; wherein the user provides property location information, user contact information, and a plurality of property condition information; identify a service provider within the database which provides the requested service within the area of the property location; retrieve a pricing profile of the service provider for the service requested; calculate an instant quote based on the pricing profile, the property location information and the plurality of property condition information; display the instant quote to the user; and transmit the user contact information and property information to the service provider. The property location information is at least comprised of a zip code. The pricing profile may contain a plurality of pricing variables. The pricing variables may be comprised of at least two of: (1) a base price for the service; (2) a component price for the service; (3) a trip charge for the service; (4) a minimum job price for the service; and (5) discount variable for the service. The identification of the service provider may be based on subscriptions of the service provider where the subscriptions are based on zip codes. The zip code subscriptions may be auctioned to the service provider who provides the highest subscription bid. One or more zip codes may be combined to create a zip code cluster and the zip code cluster subscription may be auctioned to the service provider who provides the highest subscription bid. The system may also comprise a scheduling software module wherein the user can schedule the service based on the schedule of the service provider. The system may also comprise a merchant software module wherein the user can pay for the service based on the instant quote. The merchant software module may process payments directly within the merchant account of the service provider. The service provider may be charged a fee for each lead sent via the system.

The present invention also provides a method for providing real time cost estimates for service projects to users which includes the steps of: receiving a request from a user for a real time price quote for a service related to a property; wherein the request includes property location information, user contact information, and a plurality of property condition information; identifying a service provider within a database which provides the requested service within the area of the property location; retrieving a pricing profile of the service provider for the service requested; calculating an instant quote based on the pricing profile, the property location information and the plurality of property condition information; transmitting the instant quote to a user device; displaying the instant quote to the user; and transmitting the user contact information and property information to the service provider.

The method may use the zip code of the property location information to identify service providers. The method may also calculate the instant quote based on a plurality of pricing variables within the pricing profile. The pricing variables are comprised of at least two of: (1) a base price for the service; (2) a component price for the service; (3) a trip charge for the service; (4) a minimum job price for the service; and (5) discount variable for the service. The step of identifying at least one service provider is based on which service providers have subscribed to a zip code for the identified service. The method may also include the step of auctioning the zip code subscription to the service provider who provides the highest subscription bid. The method may also include the step of grouping two or more zip codes together to create a zip code cluster.

These and other objects, features, and/or advantages may accrue from various aspects of embodiments of the present invention, as described in more detail below.

### BRIEF DESCRIPTION OF THE DRAWINGS

The foregoing summary, as well as the following detailed description of the invention, is better understood when read in conjunction with the appended drawing. For the purpose of illustrating the invention, exemplary constructions of the invention are shown in the drawings. However, the invention is not limited to the specific methods and instrumentalities disclosed herein.

FIG. 1 provides an exemplary illustration of a system diagram of the present invention.

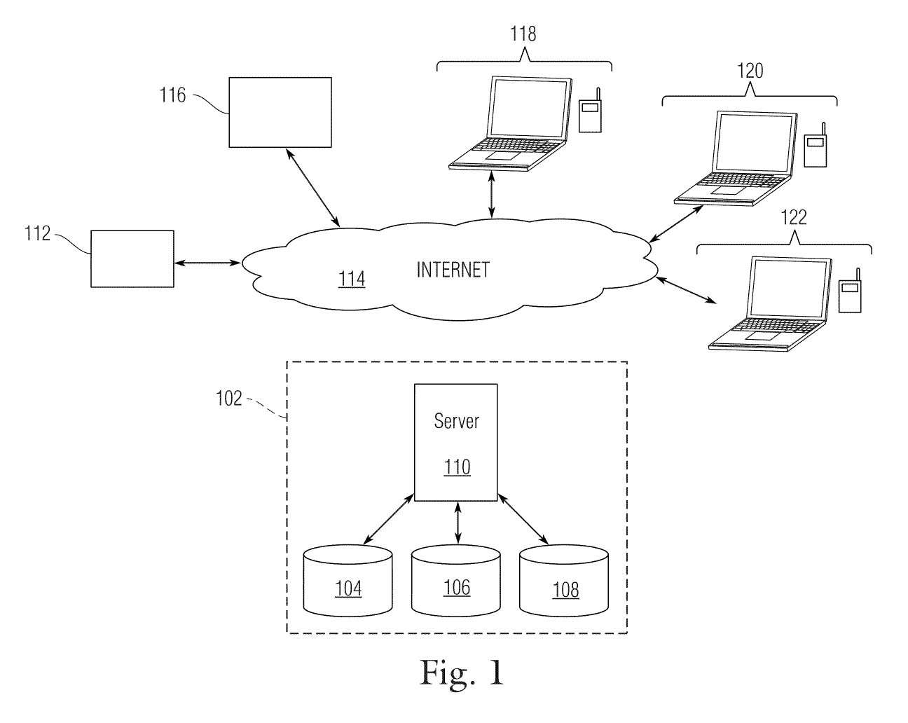

FIG. 2 provides an exemplary illustration of a flowchart of a user obtaining a quote using the present invention.

FIG. 3 provides an exemplary illustration of a flowchart of a contractor creating and managing his business profile.

FIG. 4 illustrates a flowchart of the various steps used to derive the real time quote for services.

FIG. 5 provides a screenshot of the webpage where a contractor can modify his business profile information.

FIG. 6 provides a screenshot of the webpage where a contractor can update the services he provides to customers.

FIG. 7 provides a screenshot of the webpage where a contractor can adjust the pricing profiles for their services.

FIG. 8 provides a screenshot of the webpage where a contractor can subscribe to postal/zip code clusters.

FIG. 9 provides a screenshot of the webpage where the website administrator can adjust the postal code clusters and rates.

FIG. 10 provides a screenshot of the webpage where a contractor can adjust their schedule and availability for accepting appointments through the system of the present invention.

FIG. 11 provides a screenshot of the webpage where the customer is provided a real-time accurate quote through the system.

### DETAILED DESCRIPTION OF EXEMPLARY EMBODIMENTS

Particular embodiments of the present invention will now be described in greater detail with reference to the figures.

The present invention provides for a main system 102 which is comprised of one or more servers 110 in communication with or connected to one or more databases 104, 106, 108. The databases 104, 106, 108 may be comprised of multiple databases, including, but not limited to: (1) one or more databases or tables 104 used to store information related to business profiles of contractors, affiliates, and users/consumers; (2) one or more databases or tables 106 used to store information related to available services by location or zip code; and (3) one or more databases or tables 108 used to store information related to project information and management. The databases 104, 106, 108 may also contain information of past services associate with each user, customer, or property location. In addition, the system may contain information on historical pricing, inflation, interest rates, national or regional fuel and labor costs and other information relevant to providing accurate real time quotes. The system can easily expand the number of servers, databases, or instances of software to handle vast numbers of services, contractors, and users.

Various applications, software, and programs reside on the one or more servers 110 and enable the user to access the system's web interface, the matching database application, the services application, the contractor profiles, the affiliate profiles, and the project information and management application. The system organizes the application and the content on the web interface such that only some applications and content are publically available and viewable by the user. Some applications and content may be restricted or private such that it may only be viewed by certain type of users, or may only be accessible after the user has been authenticated with a username and password. In the preferred embodiment, all passwords are randomly generated alphanumeric strings of 8-10 characters that are unique to each account holder. However, it should be noted that the system may be designed such that users may create their own unique passwords.

Users may access the system's interface by connecting to the system via the internet or telecommunications network through a computer, mobile device, or smartphone browser, or by downloading a mobile application onto their mobile device. Further, the present invention is primarily utilized by five main types of users: (1) consumers 122; (2) contractors 120; (3) web administrators 118; (4) affiliates 116; and (5) advertisers 112.

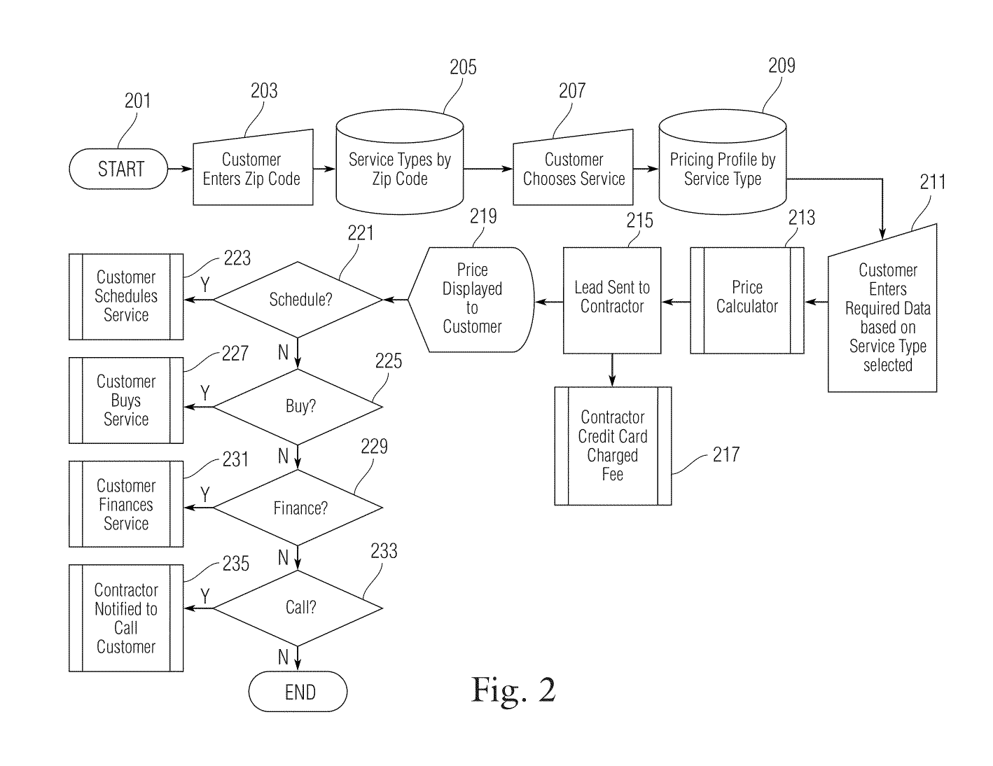

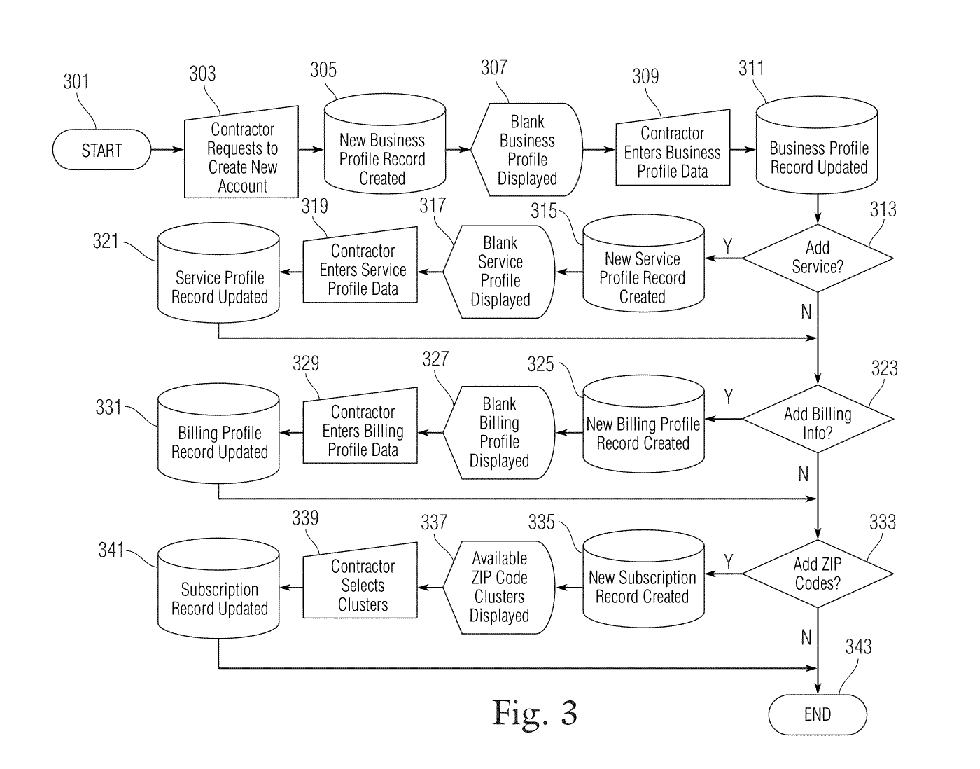

Consumers 122, such as homeowners, property managers, and renters, may use the system to search for local contractors, obtain real-time quotes, and schedule services such as home-related services through the matching database application. A flowchart for obtaining a quote is illustrated in FIG. 2. To begin or start 201 obtaining a quote, the consumer 122 must first log into the system and enter the matching database application either through his computer or mobile device. The consumer 122 enters his zip code in step 203. In order to find contractors located near the consumer 122, the system in step 205 organizes all service types (i.e. house cleaning, steam cleaning, HVAC, etc.) by zip code. The customer selects a service in step 207. The service selection step can be done in a variety of manners, including selecting a service from a dropdown menu, using a search box, or choosing a desired service from a graphic or even an interactive pictorial of a property, its rooms, and the systems or components with the rooms (i.e. the sink in a kitchen). In step 209, the system prepares the pricing profiles based on the selected service type. The pricing profile captures all information that the contractor 120 provides the system to assist in generating a quote or estimate to the consumers 122. Each service offered by the system has a consistent pricing profile that is completed by each contractor 122 when they add a given service to their business profile during account registration. The creation of a contractor 122 profiles and the pricing profile are further discussed in conjunction with FIG. 3.

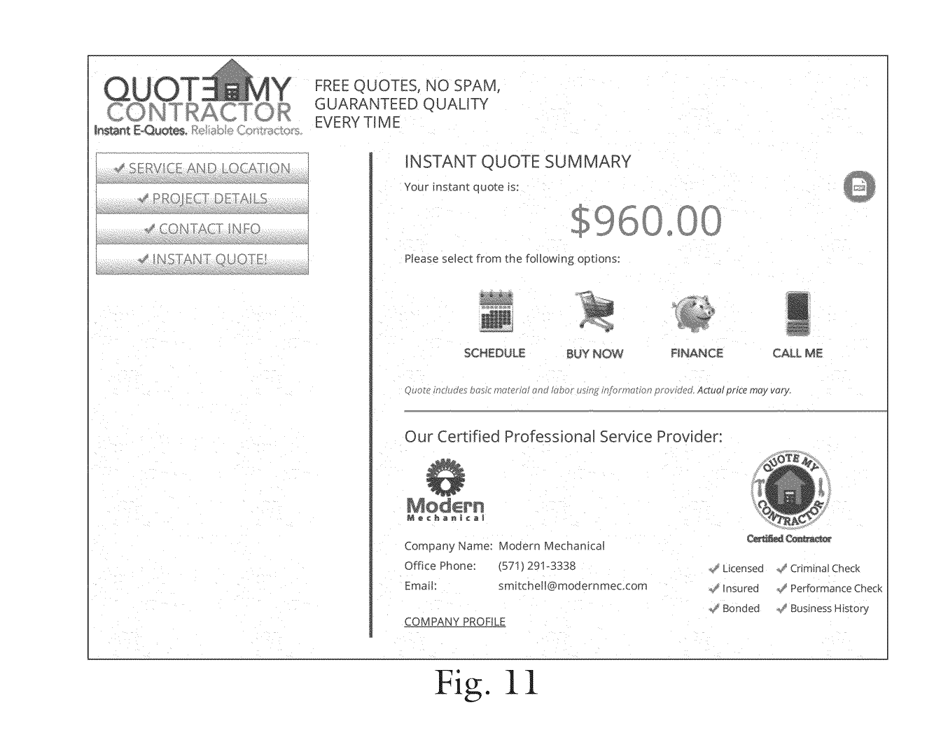

The consumer 122 enters all the required data based on the service type selected in step 211. For example, if the consumer 122 selected house cleaning, the consumer 122 will enter the number of rooms and type of rooms to be cleaned. Based on the entered data and the contractor's pricing profile, the system in step 213 calculates an estimated price. A discussion of the estimated pricing calculation process is described in conjunction with FIG. 11. The customer lead is instantly and automatically sent to the contractor 120 in step 215 and the contractor's credit/debit card or account is automatically charged a fee for the customer lead in step 217.

In step 219, the estimated price quote is displayed to the customer 122. The customer 122 has the option of scheduling or booking the service in steps 221 and 223. Also, in step 223, upon the user scheduling or booking a service, an automatic notice is sent to the contractor. This may also automatically fill in the appointment within a contractor's schedule synced to or through the system. In steps 225 and 227, the customer 122 has the option of paying for the service upfront with a major credit/debit card or other authorized payment means, such as PayPal. In steps 229 and 231, the customer 122 also has the option of using a third-party vendor to finance the service. In steps 233 and 235, the contractor 120 is notified to call the customer 122 to answer any customer questions or, if not already scheduled, to schedule the project.

Additionally, the system can review information related to that customer, the identified property or other properties in the area and recommend and market specific services and/or contractors based on the information provided by the consumer. Information may include, but not limited to, major and minor characteristics of the property and the property's condition.

Once the project has been scheduled, an email or other form of communication is sent to the customer that contains an electronic calendar event specific to their appointment, the service(s) being performed, the contractor performing the work, the contractor's contact information, a reminder and additional details that are necessary. The contractor may also access the project and customer information and can export and/or print a copy of the estimate, quote, or proposal for his records or to provide directly to his employees, which would include customer and property information.

Before utilizing the system, the consumer can create an account that allows him to create/edit a username, password, address information, property information, and communication preferences. Through the consumer account, he can also update active quote information, view all quotes created within a given period of time, submit feedback on work performed by the contractor, and provide general feedback to the website, such as compliments, challenges and suggestions. The consumer may also use the system without creating an account or as a guest.

By way of example, a customer wants to get the first floor of his house cleaned. Using his computer, the user 122 accesses the system 102 through the internet 114 and enters the online services matching database. The customer enters his zip code (or other location information such as city/state). Based on the customer's zip code, the system organizes the service types available based on contractors who have registered to provide services in or near the customer's zip code. On the system's web interface, the customer selects “House Cleaning” as the service type. The system pulls the pricing profile input criteria for a house cleaning service and prompts the user to enter additional information based on the cleaning pricing profile. For purposes of this example, the user is prompted to enter the number of rooms to be cleaned, the type of rooms to be cleaned (i.e. bedroom, kitchen, bathroom, etc.), the area or size to be cleaned (i.e. area in square feet), frequency, and other related questions. On the web interface, the customer enters 2 bedrooms with an area of 150 square feet per room and one bathroom with an area of 100 square feet and selects ‘Weekly’ as the frequency with which the consumer's home will be cleaned. They system then identifies the contractor subscribed to that zip code for cleaning services and obtains their house cleaning pricing profile information. By combining the data entered by the consumer with the contractor's pricing profile, the system calculates a price quote of $50 per cleaning and displays this price quote to the customer. Using the system, the customer schedules the house cleaning service for every Monday at 3 P.M. and pays for the service upfront using a major credit/debit card. The system of the present invention is capable of taking the credit/debit payment directly from the user or populating the screen with the contractor's merchant account (i.e. PayPal) information such that the credit/debit card information is processed directly by the contractor's merchant account. Once scheduled, the system notifies the contractor of the scheduled appointment and requests that they confirm details with the customer.

Contractors 120, such as plumbers, electricians, and cleaners may use the system to receive quality customer leads specific to the contractor's trade, manage their business and service profiles, and manage leads. More particularly, contractors 120 may use the system to: (1) create an account; (2) recover their account password; (3) deactivate their business account; (4) update their business' unique profile; (5) update pricing components for each service offered by a business; (6) update zip codes that have been subscribed and assigned to the business; (7) manage customer leads; (8) manage their schedule and availability; and (9) update the status of customer leads assigned to the business.

Through the present invention, contractors may purchase subscriptions of U.S. Postal codes or zip codes or in “clusters” of postal/zip codes from which they will receive all leads originating from that postal code for the service they offer (e.g. plumbing, electrical, HVAC, etc.). The number of postal or zip codes assigned to a cluster varies and may be changed over time as determined by the web administrators 118. In the preferred embodiment, contractors 120 purchase subscriptions on a monthly basis. However, the present invention may be designed such that subscriptions may be purchased on a yearly, weekly, or daily basis. The system also sends email notifications automatically to active subscription holders (i.e. contractors) to renew their subscription every month and to all contractors offering a service type, but not subscribing to any one specific postal code. The system will also notify contractors when zip codes are available for bidding, such as when a current contractor's subscription is ending. The system also allows for contractors to elect to automatically renew zip codes and zip code clusters at the end of the subscription period.

The system also enables postal code clusters to be auctioned at a rate determined by the local contractor market. For example, the density or average household income of certain residential postal codes may command a higher periodic subscription rate given the increased opportunity for business or higher fees or rates which can be charged.

Contractors may also purchase zip code clusters as a primary recipient or secondary recipient. Primary recipients will be charged the full amount for the opportunity to receive customer leads from that cluster. Secondary recipients will be charged a lesser amount and will only receive leads from that zip cluster if the primary recipient elects to turn their leads “off” temporarily or if a job falls below their minimum price for a service. In such cases, the referrals not sent to the primary recipient are sent to a secondary application in the system. The secondary contractor application processes the leads and submits them to the secondary recipient. By default, if there is no secondary contractor or service provider, any referrals may default to the primary contractor's minimum price for the service. If no contractor exists for a given area, the system can provide the lead to a contractor in the system servicing a nearby zip code and use their pricing profile information to provide a quote but may also apply a markup such as 10% to the estimate.

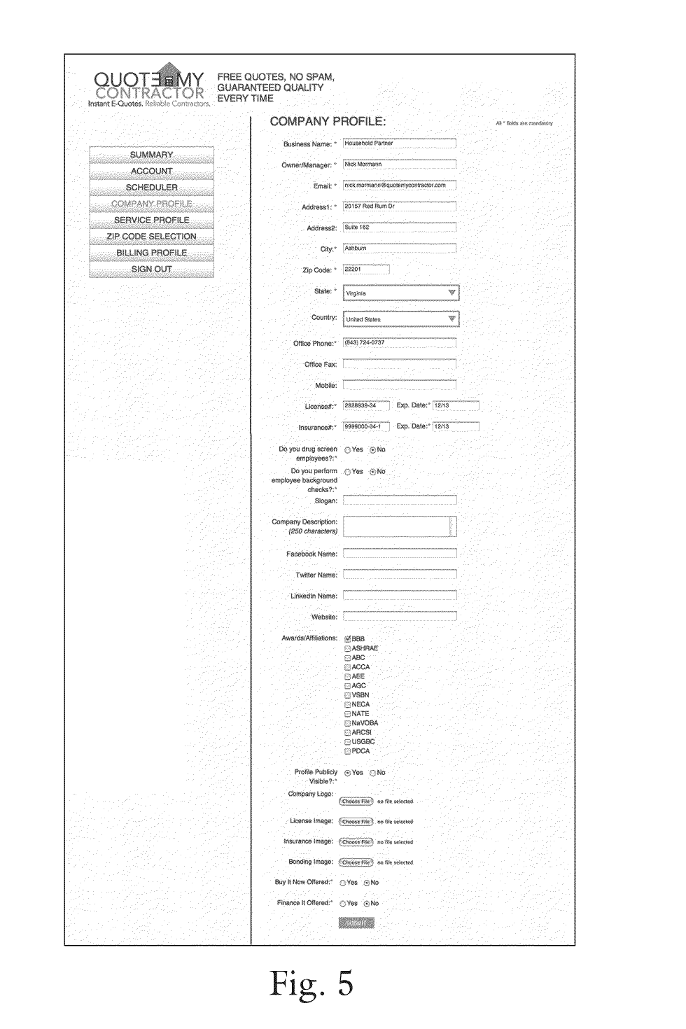

FIG. 3 illustrates a flow diagram of a contractor 120 creating a new account on the system. In step 303, the contractor 120 accesses the system through the Internet using his computer, mobile device, or smartphone and requests to create a new account. The system in step 305 creates a new business profile record in the database and displays the blank business profile to the contractor 120 in step 307. In step 309, the contractor enters all necessary business profile data and the system updates that contractor's unique business profile record in step 311. The contractor 120 can add, modify, or remove this company information in real-time and the system will update the business profile accordingly. As seen in FIG. 5, which provides a graphical user interface of the company profile input screen, the contractor 120 can change his business name, owner/manager name, email, address, logo and other relevant information. The user may also select if they will accept credit/debit card payments or financing through the system.

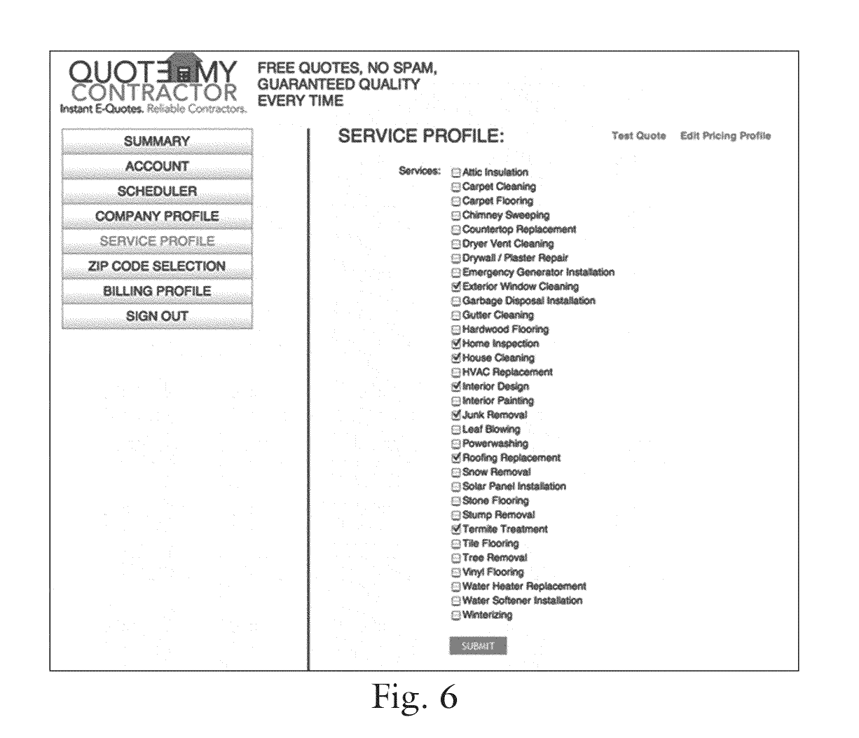

Once a profile has been created, the contractor 120 has the option of adding its services in step 313. As seen in FIG. 6, which provides a graphical user interface of the service profile input screen, the contractor 120 may add services such as house cleaning, HVAC, lawn mowing, and other common services. If the contractor 120 decides to add services, the system creates a new service profile record in the database in step 315 and displays a blank service profile to the contractor 120 in step 317. The contractor 120 enters data relating to its services and the corresponding price profiles in step 319. Additionally, the contractor 120 can add, modify, and remove the questions to be asked for a given service. Each service offered by the contractor 120 has a consistent pricing profile which is completed by the contractor 120 when he adds a service to his business profile. These pricing profiles can be modified, added, unselected, or removed in real-time even after the service has been added to a contractor's profile. The system updates the unique service profile record in step 321. The contractor 120 may add as many services as desired or necessary, as well as add, modify, or remove services at any time.

The contractor 120 also has the option of adding billing information in step 323. If the contractor 120 decides to add billing information, the system creates a new billing profile record in the database in step 325 and displays a blank billing profile to the contractor 120 in step 327. The contractor 120 enters data into the billing profile in step 329, and the system updates the billing profile record in step 331.

In addition, the contractor 120 may purchase a subscription for a U.S. postal or zip code or clusters of postal/zip codes in step 333. If a contractor 120 decides to purchase a subscription, the system creates a new subscription record in the database in step 335 and displays available postal/zip codes or postal/zip code clusters to the contractor 120. The contractor selects the postal/zip codes or postal/zip code clusters in step 339. The system updates the subscription record in step 341. The contractor account set-up and modification process terminates at step 343.

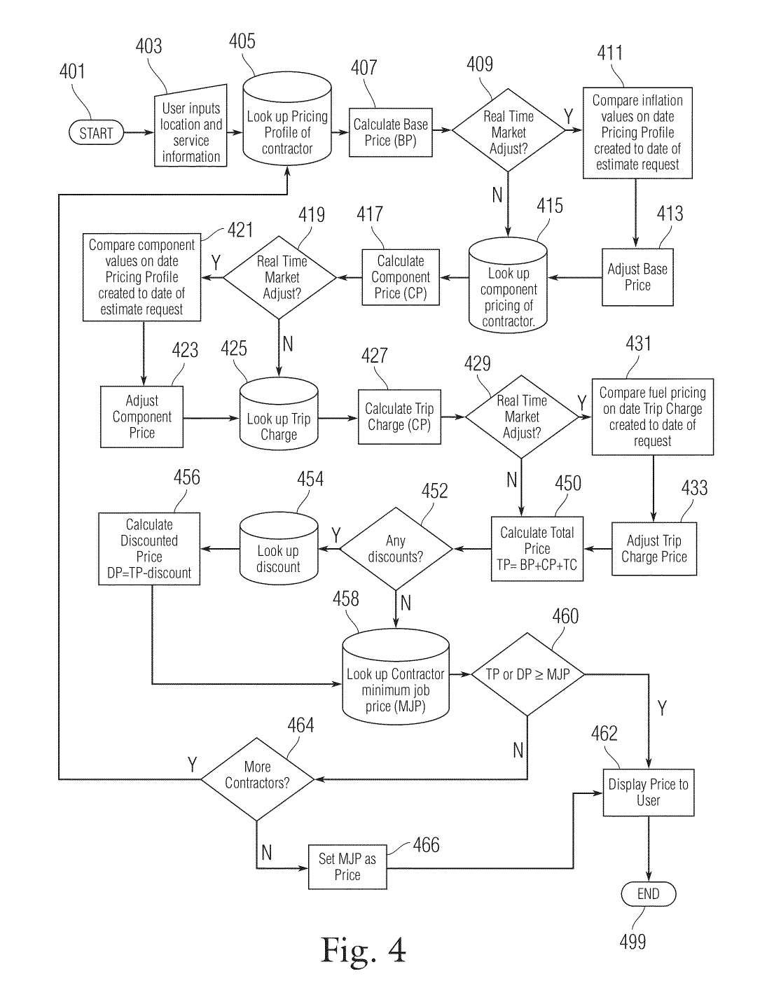

The process of calculating the real-time price quote will now be described in conjunction with FIG. 4. When a user comes to a website featuring the real-time accurate quote system of the present invention they start 401 the process by inputting their location and service information 403. The location information is ideally a zip code but may be a city or town and state. Based on the location information and the service selected the system identifies the contractor associated through their subscription with the zip code or location. The system retrieves, step 405, the pricing profile information of the contractor for the selected service. As previously discussed, the user would be prompted, in step 403, to provide details and responses to questions about the service which is needed. Based on the contractor's Pricing Profile and the information and responses from the user the system calculates a base price (BP) in step 407.

The contractors may have the option to have one or more pricing parameters adjusted by a real time market adjustment. Specifically, the system may provide contractors the ability to adjust their rates up or down based upon changes in market indicators and pricing from the date they created their Pricing Profile compared against current market indicators. Since many factors go into the Pricing Profile, it can be cumbersome for contractors to update the Pricing Profile on a continuous or even periodic basis. Therefore, the system enables the contractor to have an automatic adjustment to pricing. The automatic adjustment may be set to only protect the contractor in one direction such that it increases the estimated price when there is market inflation but does not decrease the estimated prices when there is deflation. Further, the system may be set to adjust only when the deviation or market adjustment is over a certain threshold (i.e. 3%).

As seen in FIG. 4, in step 409, the system determines if the user has a real time market adjustment. If yes, in step 411, the system compares market indicators or inflation values on the date the Pricing Profile was created to the date of the estimate request. The system then adjusts the BP, step 413, to account for the market increase or decrease.

In step 415, the system looks up the component pricing of the contractor. Based on the user input from step 403 the system calculates a component price (CP). Again, in step 419, the system determines if the user has a real time market adjustment. If yes, in step 421, the system compares market indicators on component pricing values on the date the Pricing Profile was created to the date of the estimate request. The system then adjusts the CP, step 423, to account for the market increase or decrease in component pricing.

In step 425, the system looks to see if the contractor has any trip charge (TC). The trip charge may be a flat fee per location or may be a mileage rate. The system, step 427, may then determine the distance from the contractor to the property and calculates the trip charge (TC) from the flat rate fee, which may be based on distance, or by multiplying the per mileage rate by the distance in miles. In step 429, the system determines if the user has a real time market adjustment. If yes, in step 431, the system compares market indicators such as fuel price values on the date the Pricing Profile was created to the date of the estimate request. The system then adjusts the TC, step 433, to account for the market increase or decrease in fuel or trip pricing.

The system, step 450, then calculates the total price (TP) by adding the base price (BP), component price (CP), and trip charge (TC) together. The system determines, step 452, if there are any applicable discounts. If yes, the system looks up the discount, step 454 and then calculates the discounted price (DP) by reducing the total price by the discount amount. If the answer to step 452 is no, or after the discounted price is determines, the system determines if the total price (TP) or discounted price (DP) are equal to or greater than the contractor's minimum job price. If yes, the total price (TP) or discounted price, if a discount applies, is displayed to the user in step 462. If not, the system determines, step 464, if there are additional or secondary contractors for that service subscribed to the zip code or area. If yes, the process starts over by looking up the pricing profile of the secondary contractor in step 405 and the process repeats. If there are no more contractors, the system sets the estimate as the contractor's minimum job price (MJP) in step 466. The MJP would then be displayed to the user in step 462. The process terminates 499 once the estimated price is displayed.

The system automatically calculates the distance between the contractor's location and the consumer's location, and applies a surcharge as needed. Additionally, the system can display the average price of services quoted, purchased, or financed by the postal code in which the consumer is located, as well as surrounding postal codes.

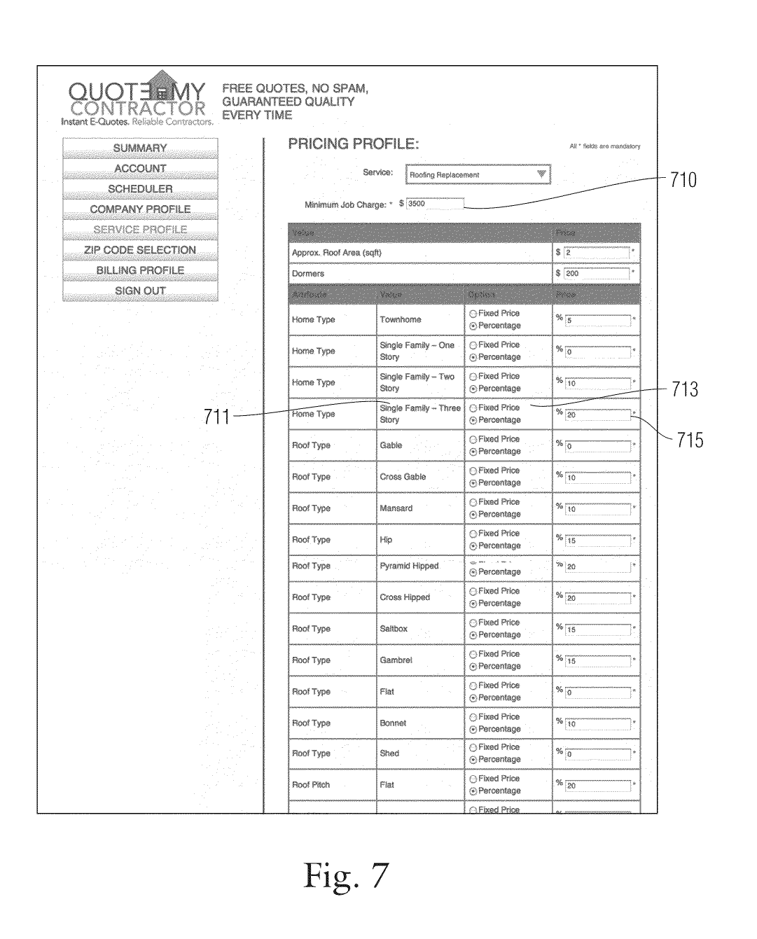

Contractors also have the option to markup or discount the pricing profiles and quotes for all or specific services, geographic areas, service pricing components (labor or materials) in real-time at a later date. These pricing markups/discounts can be in the form of either a percentage or fixed amount. As depicted in FIG. 7, an illustration of the graphical user interface of the pricing profile screen for a contractor for a roofing replacement service is provided. The contractor can change the Pricing Profile in real-time to require a minimum job charge (i.e. $3,500) and an upcharge (i.e. 20%) for a select value or property (i.e. single family-three story house). This is accomplished by going to the minimum job charge window 710 and adjusting the charge or by going to the price value cell 711 for a specific value and adjusting the option cell 713 (i.e. fixed price or percentage) and the price in cell 715. In this example, the contractor can select “Home Type” and “Single Family-Three Story” and then inserting the number 20 into the text box 715 and checking off the box associated with the word “percentage” in cell 713. Additionally, contractors 120 can set a specific length of time the pricing profile and quotes will be valid and honored. The contractor 120 can also include legal language, if any, that will be presented to the consumer with each quote.

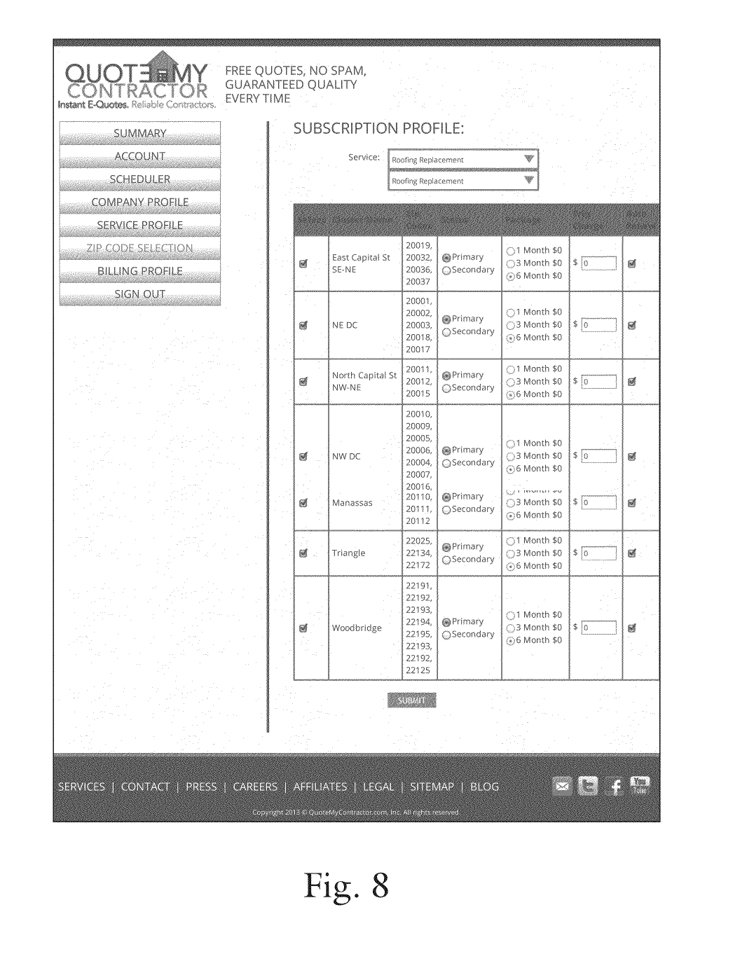

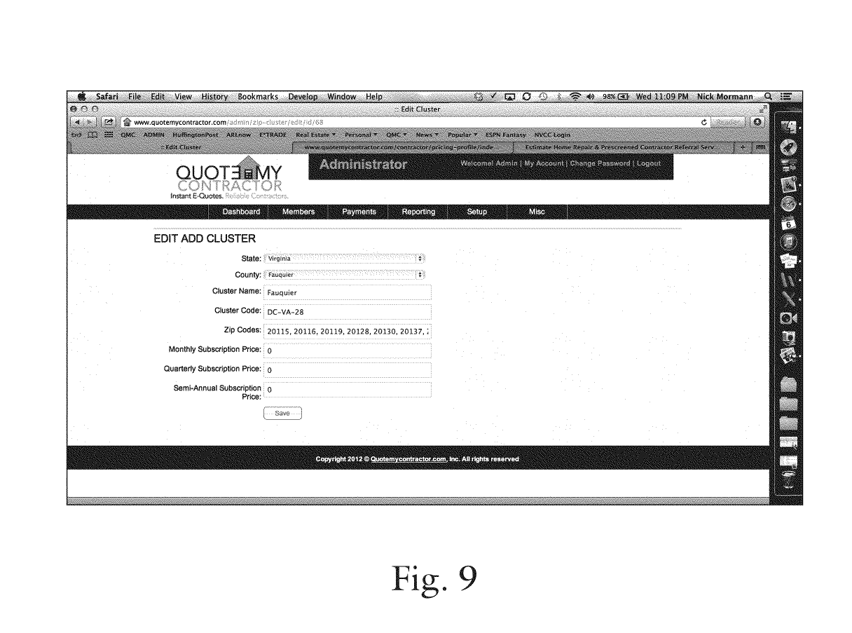

The contractor subscription functionality and the locality or zip code clustering functions will not be described in conjunction with FIGS. 8 and 9. FIG. 8 provides an illustration of the graphical user interface of the subscription profile screen for a contractor to select the clusters or zip code groupings they want a subscription to. They can select to be the primary or secondary contractor and can determine which package or duration they want. They can add any trip charge to that cluster and can select to auto renew. As competition to be the primary or secondary contractor for a given cluster increases, the system can automatically adjust the package pricing and duration to enable contractors to bid to be the contractor of choice to service new leads in that zip code cluster.

FIG. 9 provides an illustration of the graphical user interface of the zip code cluster edit screen for a system administrator to create or add a cluster, edit or add zip codes to a cluster, and to set the minimum pricing for the subscriptions per interval. As illustrated in FIG. 9, the website administrator can manually enter and designate zip codes 20115, 20116, 20119, 20128, 20130, and 20137 and provide a cluster name (i.e. “Fauquier”) as well as a cluster code (i.e. DC-VA-28). The subscription pricing can be established for a monthly subscription price, a quarterly subscription price, and a semi-annual subscription price. Although depicted as a set price by the administrator in the user graphical interface, the system can employ and automated bidding system which enables contractors to set their maximum subscription price with the primary contractor selected based on the maximum subscription price bid for that zip code or cluster. The secondary contractor may be selected based on the second highest subscription price bid for that zip code or cluster.

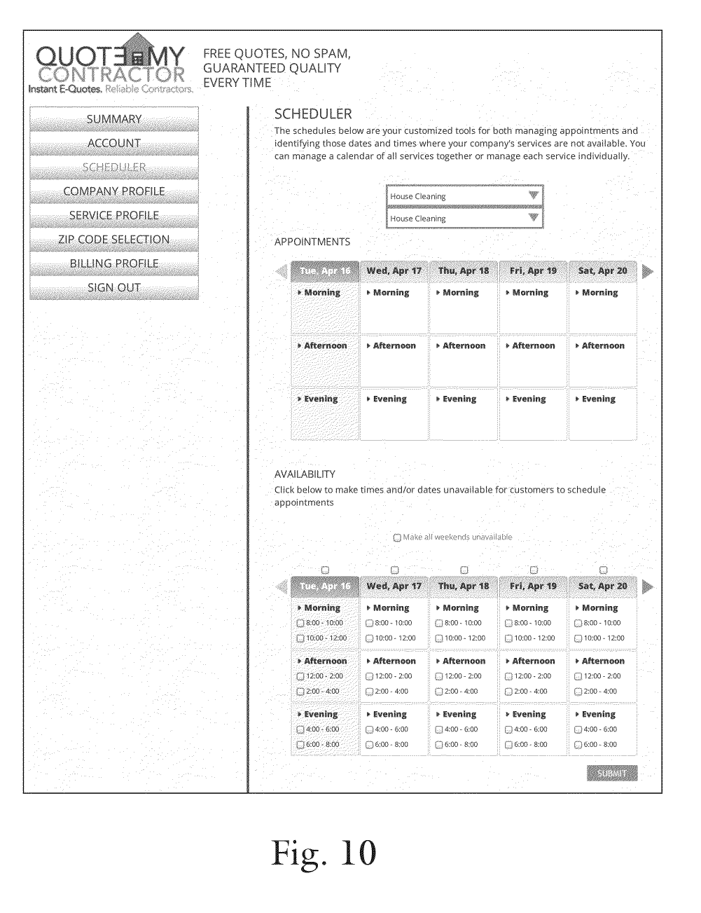

The system also enables contractors and users the ability to set schedules for accepting appointments and scheduling work. As seen in FIG. 10, a graphical user interface of the contractor scheduling module is illustrated. The scheduling module enables the contractor, via appointment module 950, the ability to designate set days of the week (i.e. Tuesday and Wednesday) and set blocks in the day (i.e. from 10 a.m.-12 p.m.) as the only time it will conduct a specific service. The schedule module will also show the contractor a schedule of all services which have been booked by users so they can plan their work day accordingly.

Ultimately, once the system has the relevant information from the user regarding the service needed, and the system has computed the pricing based upon the contractor's pricing profile, the system provides the user an instant quote. FIG. 11 provides an illustration of the graphical user interface of the screen provided to a user upon receiving an instant quote. Once the user has the instant quote they may schedule the appointment, buy or pay for the service, finance the service, or request the contractor to call or contact the user.

In addition, the system has various other features and functions which are beneficial to the user and contractor. The contractor 120 can also register multiple sub-accounts that interact with the master account for the company, i.e., parent-child relationship. These sub-accounts can be assigned roles and responsibilities as well as have set or limited permissions. Instead of registering multiple sub-accounts, the contractor 120 can also assign quotes and leads to specific team members based on customizable, self-determined characteristics. Additionally, the contractor 120 can determine which team members receive automatic notifications based on customizable, self-determined characteristics.

Additionally, the system can be employed as a distributed model such that the contractors may embed the functionality on their own or many websites. Since many contractors may not have the ability to create a real time instant quote generating system and scheduler having the features of the present invention, the system can enable contractors to use an iframe or call/request to have such functionality displayed on their website. By using an iframe or call schema, contractors can provide a system on their own website which will retrieve appropriate information to display the service related questions, contractor pricing profile, and determine and display a real time quote to consumers.

By way of example to illustrate the system of the present invention, XYZ Corporation offers house cleaning and carpet cleaning services. XYZ Corporation accesses the system through the internet using a computer and creates a business profile as seen in FIG. 5. XYZ Corporation adds house cleaning and carpet cleaning services to its business profile as seen in FIG. 6. The system prompts XYZ Corporation to complete a pricing profile associated with the house cleaning and carpet cleaning services as seen in FIG. 7. In completing the pricing profile, XYZ Corporation includes prices they charge to clean each bedroom, bathroom, window, or related service. XYZ Corporation may also choose to add additional services, such as carpet cleaning. After a creation of the business profile, the XYZ Corporation purchases a cluster of zip codes in Woodbridge, Va. as see in FIG. 8. A week later, a customer located in the Woodbridge, Va. uses the system to obtain a quote for cleaning his house. Based on information provided by the customer, the system calculates the price quote using the contractor's pricing profile as set forth in conjunction with FIG. 4. Because Woodbridge, Va. is within the cluster purchased by XYZ Corporation, the customer lead is sent to the XYZ Corporation and the price quote is displayed to the customer (see FIG. 11). Using the system, the customer schedules the house cleaning service and pays for the service. XYZ Corporation is then notified to call the customer regarding the scheduled house cleaning.

In addition to the features and functions previously described, the system also enables administrators 118 to manage all customer records and project information, manage all contractor profiles, and produce essential reports for contractors 120, affiliates 116, and advertisers 112. More particularly, the web administrators 118 may use the system to: (1) create a contractor account on their behalf; (2) recover account password for contractors; (3) deactivate business accounts; (4) update a business' unique profile on their behalf; (5) update the pricing components for each service offered by a business on their behalf; (6) update the status of customer leads assigned to businesses on their behalf; (7) create an affiliate account and generate a password; (8) recover an affiliate's account password; (9) deactivate affiliate accounts; (10) update an affiliate's unique profile; (11) update the status of customer leads associated with affiliates; (12) generate basic essential reports (i.e. reports for system management, consumers, contractors, affiliates, and advertisers); (13) assign a postal/zip codes subscription or clusters of postal/zip codes to a contractor and charge the contractor purchasing the codes; (14) manage the postal/zip codes assigned to a contractor (i.e. expire a specific postal/zip code or cluster of postal/zip codes or update the status of the cluster); (15) create and push email to all contractors offering the same service type as that of the expired owner with a notification of available zip codes); (16) add and/or delete a U.S. postal or zip code to a cluster; and (17) manually charge or refund a contractor's or customer's credit/debit card.

Affiliates 116 may use the system to receive credits or referral fees for sending consumers 122 to the system's web interface. Additionally, affiliates 116 may use the system to: (1) create an affiliate account; (2) recover account password; (3) deactivate an affiliate account; (4) update an affiliate's unique profile; (5) update the status of customer leads associated with affiliate; (6) track earned referral fees; and (7) transfer referral fee money to a bank account. Advertisers 112 may also use the system to advertise their products which may be highly applicable to the service industries. For example, a large heating or air conditional manufacturer may want to advertise their brand and products so users are inclined to select their brand if they are seeking quotes for heating and air condition service which might require replacement units or parts. Advertisers may also view website statistics (such as unique page views, visitor information, and consumer information) and to purchase advertising.

In the preferred embodiment, the system is designed to handle home-related services, but it should be noted that the system may also be designed to handle all types of services, including professional and business related services.

Further, the system can be used to build a comprehensive database of service based information for customers, specific properties or addresses, and zip codes. Such information might include quotes generated, services purchased, property conditions, major equipment age and conditions, and other information obtained from use of the system or integrated from other sources. The database may integrate property records to identify the owners, year the property was built, value of the property as such. Further, the system may allow a service provider to provide input on other services the property may need even if the contractor or service provider does not provide those services. For example, a contractor who handles painting may determine there is damage related to a leak which would require a plumber. The painting contractor could provide such information to the system, which may prompt the user to seek a quote for a new service and identify a lead for the plumbing contractor for that zip code. The plumbing contractor can also market to the user and the painting contractor can receive credit for the user coming back to the site for the new quote, for the lead, or for completed jobs. Continued development of the database will enable combined maintenance plans and related services to be marketed to users and property owners.

The examples provided herein are merely for the purpose of explanation and are in no way to be construed as limiting of the present method and product disclosed herein. While the invention has been described with reference to various embodiments, it is understood that the words which have been used herein are words of description and illustration, rather than words of limitation. Further, although the invention has been described herein with reference to particular means, materials, and embodiments, the invention is not intended to be limited to the particulars disclosed herein; rather, the invention expands to all functionally equivalent structures, methods and uses, such as are within the scope of the appended claims. Those skilled in the art, having the benefit of the teachings of this specification, may affect numerous modifications thereto and changes may be made without departing from the scope and spirit of the invention.

It will be recognized by those skilled in the art that changes or modifications may be made to the above described embodiment without departing from the broad inventive concepts of the invention. It is understood therefore that the invention is not limited to the particular embodiment which is described, but is intended to cover all modifications and changes within the scope and spirit of the invention.

We claim:

1. A system comprising:
at least one server; at least one software application; and at least one database, wherein the system is configured to:
receive a request from a user for a real time price quote for a service related to a property; wherein the user provides property location information, user contact information, and a plurality of property condition information;
identify a service provider within the database which provides the requested service within the area of the property location;
retrieve a pricing profile of the service provider for the service requested;
calculate an instant quote based on the pricing profile, the property location information and the plurality of property condition information;
display the instant quote to the user; and
transmit the user contact information and property information to the service provider.

2. The system of claim 1, wherein the property location information is at least comprised of a zip code.

3. The system of claim 1, wherein the pricing profile contains a plurality of pricing variables.

4. The system of claim 3, wherein the pricing variables are comprised of at least two of: (1) a base price for the service; (2) a component price for the service; (3) a trip charge for the service; (4) a minimum job price for the service; and (5) discount variable for the service.

5. The system of claim 1, wherein the identification of the service provider is based on subscriptions of the service provider.

6. The system of claim 5, wherein the subscriptions are based on zip codes.

7. The system of claim 6, wherein the zip code subscriptions are auctioned to the service provider who provides the highest subscription bid.

8. The system of claim 5, wherein one or more zip codes are combined to create a zip code cluster.

9. The system of claim 8, wherein the zip code cluster subscription is auctioned to the service provider who provides the highest subscription bid.

10. The system of claim 1, further comprising a scheduling software module wherein the user can schedule the service based on the schedule of the service provider.

11. The system of claim 1, further comprising a merchant software module wherein the user can pay for the service based on the instant quote.

12. The system of claim 11, wherein the merchant software module processes payment directly within the merchant account of the service provider.

13. The system of claim 7, wherein the service provider is charged a fee for each lead.

14. A method for providing real time cost estimates for service projects to users:
receiving a request from a user for a real time price quote for a service related to a property; wherein the request includes property location information, user contact information, and a plurality of property condition information;
identifying a service provider within a database which provides the requested service within the area of the property location;
retrieving a pricing profile of the service provider for the service requested;
calculating an instant quote based on the pricing profile, the property location information and the plurality of property condition information;
transmitting the instant quote to a user device;
displaying the instant quote to the user; and
transmitting the user contact information and property information to the service provider.

15. The method of claim 14, wherein the property location information is at least comprised of a zip code.

16. The method of claim 14, further comprising the step of calculating the instant quote based on a plurality of pricing variables within the pricing profile.

17. The method of claim 16, wherein the pricing variables are comprised of at least two of: (1) a base price for the service; (2) a component price for the service; (3) a trip charge for the service; (4) a minimum job price for the service; and (5) discount variable for the service.

18. The method of claim 15, further comprising the step of identifying at least one service provider based on which service providers have subscribed to a zip code for the identified service.

19. The method of claim 15, further comprising the step of auctioning the zip code subscription to the service provider who provides the highest subscription bid.

20. The method of claim, further comprising the step of grouping two or more zip codes together to create a zip code cluster.
